(19) United States
(12) Patent Application Publication
(10) Pub. No.: US 2024/0061868 A1
(43) Pub. Date: Feb. 22, 2024

(54) GRAPHICAL USER INTERFACE OF AN INVOICE MANAGEMENT SYSTEM USING A TIMELINE DATA VISUALIZATION

(71) Applicant: Bottomline Technologies, Inc., Portsmouth, NH (US)

(72) Inventors: Leah Welch, Somerville, MA (US); Ryan Morrill, Roslindale, MA (US); Amanda Boston, North Berwick, MA (US); Caitlin Reardon, Dover, NH (US); Sandhya S. Pillalamarri, Acton, MA (US)

(73) Assignee: Bottomline Technologies, Inc., Portsmouth, NH (US)

(21) Appl. No.: 17/890,745

(22) Filed: Aug. 18, 2022

(51) Int. Cl. G06F 16/28; G06F 16/22; G06F 16/2458

(52) U.S. Cl. CPC G06F 16/287; G06F 16/221; G06F 16/2477

(57) ABSTRACT

A unique system for data visualization of invoice data and financial information on a graphical user interface is described herein. The system comprises of a visual display for invoices, the transactional data regarding these invoices, and the processing of those invoices. The visual display includes a timeline with vertical bars emanating from it, wherein these vertical bars correspond to groupings of invoice data based on user inputted and automated computer inputted information. Users input a start date for the timeline or an amount of elapsed days for the timeline. The timeline includes displaying matched and outstanding invoice data, wherein the visualization allows users to view graphically the interaction between them.

### BACKGROUND

### Prior Application

This is a priority application.

### TECHNICAL FIELD

The methods, apparatuses, and non-transitory machine-readable media described herein generally relate to techniques for tracking, analyzing, and visually displaying invoices and other transactional and financial information through an animated and interactive graphical user interface on a display screen.

### DESCRIPTION OF THE RELATED ART

There is a strong need in the financial data management industry for an intuitive and easy to use invoice management system. The current state of the art does not include a timeline data visualization for the status of financial data, including invoices.

In one example, the financial data could be invoices between a plumber and their clients. When the plumber sends their customers an invoice, the plumber needs to keep track of whether that invoice has been paid and how long it has been since the invoice was sent. Additionally, upon payment being received for one or many invoices, the plumber needs to input that information into their invoice management system. Currently, there is no easy way for the plumber to monitor their pending invoices, paid invoices, and where those invoices are in the plumber's timeline of job assignments in their business. There is a need to better visualize the progress of those invoices.

The current state of the art does not allow for a data visualization method for tracking invoices along a timeline wherein the pending invoices and paid invoices are displayed in an intuitive way. There is a strong need in the industry to improve the method of managing invoices and tracking information corresponding to them in an easy to understand way that provides all the needed information.

The present inventions address these issues.

### BRIEF SUMMARY OF THE INVENTION

A method to display the status of and information regarding financial data such as invoices is described herein.

The method may comprise of storing an invoice in a database, grouping invoices based on the date the beneficiary sent an invoice, and further grouping those invoices based on transactional factors into data sets. These data sets include an auto matched data set, a manually matched data set, and an outstanding data set.

The method may further comprise of displaying vertical bars or portions thereof in an order based on a timeline, wherein the user sets a start date of the timeline by inputting a date in the past or an elapsed amount of time, the end date of the timeline is the present day, the timeline is a horizontal line, the vertical bars emanate from the horizontal line, and there are multiple layers of these vertical bars.

The method may further comprise of displaying each layer of vertical bars as a different color, wherein a layer of vertical bars corresponding to the auto matched data set protruding upwards, a layer of vertical bars corresponding to the manually matched data set stacked above the layer of the auto matched data set protruding upwards, and a layer of vertical bars corresponding to the outstanding data set protruding downwards. The height of each vertical bar corresponds to the number of invoices from that date in that data set and the user inputs which layer or layers of vertical bars to be displayed on the timeline.

The method may further comprise of displaying a total monetary value of the outstanding data set, wherein the timeline is demarcated by user specified time periods and the total monetary value of the outstanding data set for each time period is displayed.

The method may further comprise of displaying the invoice data on the graphical user interface, wherein the user inputs a time period on the timeline and the invoices that correspond to these dates are displayed on the graphical user interface.

An apparatus for visualizing invoice management is described herein.

The apparatus may comprise of one or more processors, a processor readable storage device coupled to the one or more processors, the processor-readable storage device including one or more instructions for grouping invoice data based on the date a beneficiary sent an invoice and grouping invoice data based on transactional factors, wherein this determination is updated automatically based on user inputs.

The apparatus may further comprise of displaying vertical bars or portions thereof in a timeline, and providing a visualization in response thereto, wherein the vertical bars emanate from a central horizontal axis line and are able to protrude upwards or downwards from the central horizontal axis line.

The apparatus may further comprise of displaying multiple layers of vertical bars and displaying each layer of bars as a different color based on the transactional factors. The height of each vertical bar corresponds to the number of invoices from that date in that data set.

The apparatus may further comprise of providing a user the option to input which layer or layers of vertical bars to be displayed on the timeline and providing a user the option to input a start date for the timeline.

The apparatus of may further comprise of displaying a total monetary value of the outstanding data set, wherein the timeline is demarcated by user specified time periods and the total monetary value of the outstanding data set for each time period is displayed.

The apparatus may further comprise of displaying the invoice data on the graphical user interface, wherein the user inputs a time period on the timeline and the invoices that correspond to these dates are displayed on the graphical user interface.

A non-transitory computer readable storage medium programmed to display the status of and information regarding financial data such as invoices is described herein.

The non-transitory computer readable storage medium may be programmed to store an invoice in a database and group those invoices based on the date the beneficiary sent an invoice.

The non-transitory computer readable storage medium may be programmed to group those invoices based on transactional factors into data sets. Those data sets comprise of an auto matched data set, a manually matched data set, and an outstanding data set.

The non-transitory computer readable storage medium may be programmed to display vertical bars or portions thereof in an order based on a timeline, wherein the user sets a start date of the timeline by inputting a date in the past or an elapsed amount of time, the end date of the timeline is the present day, the timeline is a horizontal line, and the vertical bars emanate from the horizontal line.

The non-transitory computer readable storage medium may be programmed to display vertical bars or portions thereof in an order based on a timeline, wherein there are multiple layers of these vertical bars. Each layer of vertical bars is a different color, these layers comprising of a layer of vertical bars corresponding to the auto matched data set protruding upwards, a layer of vertical bars corresponding to the manually matched data set stacked above the layer of the auto matched data set protruding upwards, and a layer of vertical bars corresponding to the outstanding data set protruding downwards.

The non-transitory computer readable storage medium may be programmed to display vertical bars or portions thereof in an order based on a timeline, wherein the height of each vertical bar corresponds to the number of invoices from that date in that data set and the user inputs which layer or layers of vertical bars to be displayed on the timeline.

The non-transitory computer readable storage medium may be programmed to display the total monetary value of the outstanding data set, wherein the timeline is demarcated by user specified time periods and the total monetary value of the outstanding data set for each time period is displayed.

The non-transitory computer readable storage medium may be programmed to display the invoice data on the graphical user interface, wherein the user inputs a time period on the timeline, wherein the invoices that correspond to these dates are displayed on the graphical user interface.

### BRIEF DESCRIPTION OF THE DRAWINGS

FIG. 1 is an electrical architecture of one embodiment.

FIG. 2 is a first screenshot of an user interface of a timeline data visualization on a portion of a display screen.

FIG. 3 is a second screenshot of an user interface of a timeline data visualization on a portion of a display screen.

FIG. 4 is a first flow chart of the timeline data visualization.

FIG. 5 is a second flow chart of the timeline data visualization.

FIG. 6 is a third flow chart of the timeline data visualization.

FIG. 7 is a third screenshot of an user interface of a timeline data visualization on a portion of a display screen.

FIG. 8 is a block diagram to illustrate the apparatus.

FIG. 9 is a fourth flow chart of the timeline data visualization.

### DETAILED DESCRIPTION

The present disclosure is now described in detail with reference to the drawings. In the drawings, each element with a reference number is similar to other elements with the same reference number independent of any letter designation following the reference number. In the text, a reference number with a specific letter designation following the reference number refers to the specific element with the number and letter designation and a reference number without a specific letter designation refers to all elements with the same reference number independent of any letter designation following the reference number in the drawings.

Graphical user interface (GUI) described herein refer to “displays,” “interfaces,” and “user interfaces.” As used herein, unless stated otherwise, the terms “display,” “interface,” and “user interface,” refer to the text, images, visual components, interactive elements, and any other visual aspects that are shown or displayed on a screen, projection, or other visual display hardware. It is thus understood that “displays” and “interfaces,” as used herein, may be provided via any type of visual display hardware, screen(s) and/or projector, without deviating from the scope of the present invention.

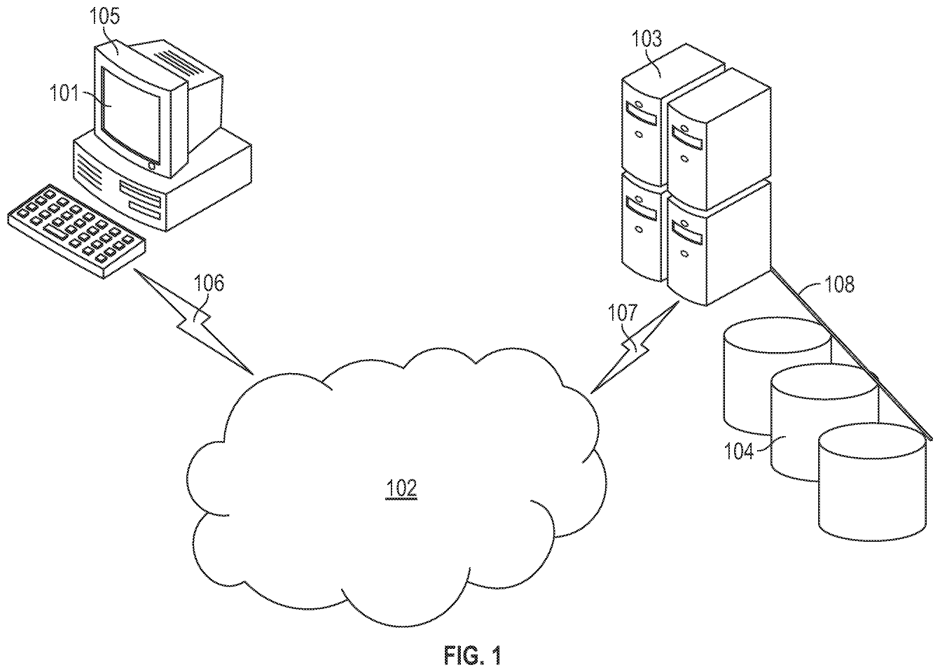

Special purpose computing may be needed to build and execute the user interface described herein. FIG. 1 shows one such embodiment. The user views the user interface described here on a personal computing device such as a personal computer, laptop, tablet, smartphone, monitor, or similar device 101. The personal computing device 101 communicates through a network 102 such as the Internet, a local area network, wireless network, or perhaps through a direct interface to the server 103, through connection lines 106 and 107, and is displayed on a screen 105. The server 103 is a high-performance, multi-core computing device with significant storage facilities 104 to store the invoices, bills, and customer data. Since this document data is dynamic and continuously updated through the present inventions, this data must be kept online and accessible so that it can be updated.

The server 103 is a high-performance computing machine electrically connected 107 to the network 102 and electrically connected 108 to the storage facilities 104. The documents may be stored in a database on the storage facilities. In some embodiments, the software in this package could be running on the server 103 with the user interface operating on the device 101, perhaps through a web browser. In that embodiment, the software includes web server code to send the display information to the web browser. In another embodiment, the device 101 could run the package or the interface running on the server 103 on the display screen 105.

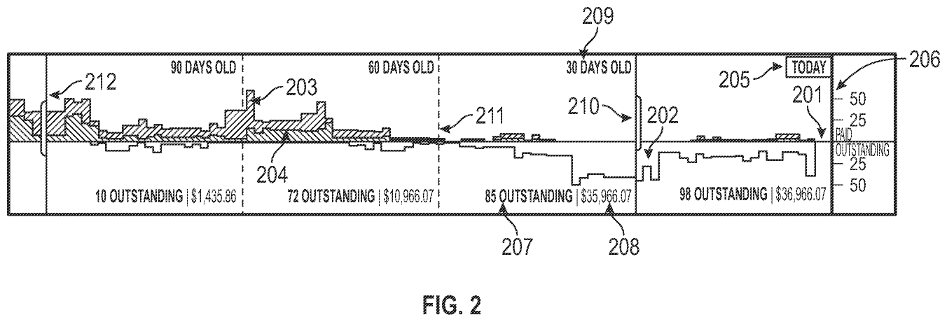

FIG. 2 shows an user interface of a timeline data visualization on a portion of a display screen. The timeline data visualization can include a horizontal line 201 drawn on the screen. The line orientation 201 can be horizontal, vertical, or diagonal. The line pattern 201 can be solid, dotted, dashed, or implied. The line 201 can be straight, zig-zagged, or curved. The line color 201 can be black, red, green, or any other color. The line 201 represents the timeline wherein the current date the user is viewing the system is on the far right of the timeline, relative the orientation of 201, demaracated by the word today 205. The horizontal line 201 could include additional line demarcations for the date that they represent. These demaracations, such as the dashed line 211, mark a date or an elapsed amount of time from the current day the user is viewing the system. This vertical line 211 could be solid, dotted, dashed, or implied. There can be multiple lines, such as the dashed line 211, along the horizontal line 201. The date or elapsed amount of time that the dashed line could represent is shown in text 209. The text 209 states the date or elapsed amount of time up to the vertical line that the text 209 is aligned adjacent too.

The timeline data visualization can also include a vertical line 206 drawn on the screen. The line orientation 206 can be horizontal, vertical, or diagonal. The line pattern 206 can be solid, dotted, dashed, or implied. The line 206 can be straight, zig-zagged, or curved. The line color 206 can be black, red, green, or any other color. The vertical line 206 includes demarcations wherein these demarcations state an amount of invoices. The demarcation include numbers such as 25, 50, 100, or any number. The demarcation numbers increase as they emanated away from the horizontal line 201.

Along the horizontal line 201 the timeline data visualization can include vertical bars 202 emanating downwards, relative to the shape and design of 201. These bars represent outstanding invoices, invoices that the user has not received payment for. Each bar represents a certain amount of time such as a hour, a day, two days, a week, or any time period. The vertical bars 202 could start just to the left of the vertical bar 206. Each vertical bar 202 left, relative to the position of the timeline, represents that amount of time further in the past on the timeline. The vertical bars 202 can be white, red, orange, or any color. The height of each vertical bar 202 is determined by the number of outstanding invoices for that time period. This height further corresponds to the demarcation numbers on the vertical line 206.

Along the horizontal line 201 the timeline data visualization can include vertical bars 204 emanating upwards, relative to the shape and design of 201. These bars represent auto matched invoices, invoices that the user has received payment for wherein the payment was matched to an outstanding invoice by the system or other non-manual inputs. Each bar represents a certain amount of time such as a hour, a day, two days, a week, or any time period. The vertical bars 202 could start just to the left of the vertical bar 206. Each vertical bar 202 left, relative to the position of the timeline, represents that amount of time further in the past on the timeline. The vertical bars 202 can be blue, red, orange, or any color. The height of each vertical bar 202 is determined by the number of auto matched invoices for that time period. This height further corresponds to the demarcation numbers on the vertical line 206.

Along the horizontal line 201 the timeline data visualization can include vertical bars 203 emanating upwards, relative to the shape and design of 201. These vertical bars 203 are stacked on top of the vertical bars 204. These bars represent manually matched invoices, invoices that the user has received payment for wherein the payment was matched to an outstanding invoice via manual user inputted matching. Each bar represents a certain amount of time such as a hour, a day, two days, a week, or any time period. The vertical bars 202 could start just to the left of the vertical bar 206. Each vertical bar 202 left, relative to the position of the timeline, represents that amount of time further in the past on the timeline. The vertical bars 202 can be green, red, orange, or any color. The height of each vertical bar 202 is determined by the number of outstanding invoices for that time period. This height further corresponds to the demarcation numbers on the vertical line 206. If there is a vertical bar 204 with a vertical bar 203 stacked on top of it, the total height for the combined vertical bars corresponds to the total number of invoices that payment has been received for.

The timeline data visualization can also include outstanding invoice information such as the number of invoices 207 and the amount of money those invoices represent 208. The time period demarcations 211 along the horizontal line 201 represent elapsed amounts of time on the timeline. The outstanding invoice information corresponding to the dates within the time period demarcations 211 can be displayed below the vertical bars 202 within the time periods.

Along the horizontal line 201 the timeline data visualization can include user interactive vertical lines which indicate a secondary time period. The vertical line 212 represents the earliest date of the secondary time period and the vertical line 210 represents the latest date of the secondary time period. Both vertical line 212 and vertical line 210 can be adjusted by multiple different user inputs such as moving the lines by using a computer mouse and dragging them across the timeline.

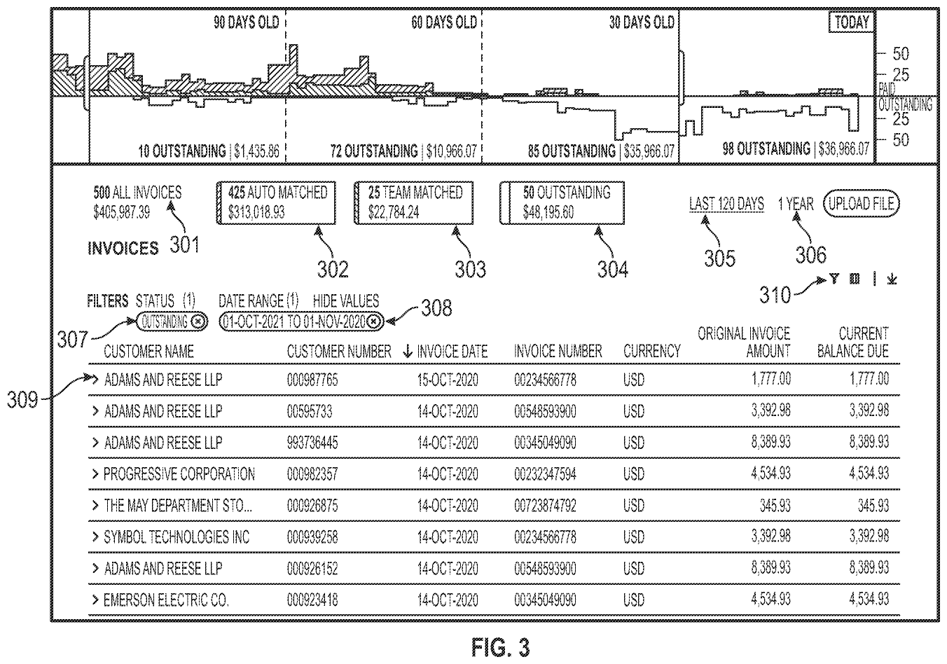

FIG. 3 shows an user interface of a timeline data visualization on a portion of a display screen. FIG. 3 can be an extension of FIG. 2. The timeline data visualization can include an user interactive filter 305 to change the length of the timeline displayed to an amount of time such as 120 days. The timeline data visualization can include an user interactive filter 306 to change the length of the timeline displayed to an amount of time such as one year.

The timeline data visualization can also displaying invoice information. The displaying of all invoices information 301 can correspond to invoice information from the total span of the timeline, total span of user information, secondary time period demarcations or other time periods along the timeline. This information 301 can display the total amount of invoices and total amount of monies related to those invoices. The displaying of all auto matched invoices information 302 can correspond to invoice information from the total span of the timeline, total span of user information, secondary time period demarcations or other time periods along the timeline. This information 302 can display the total amount of auto matched invoices and total amount of monies related to those auto matched invoices. The displaying of all manually matched invoices information 303 can correspond to invoice information from the total span of the timeline, total span of user information, secondary time period demarcations or other time periods along the timeline. This information 303 can display the total amount of manually matched invoices and total amount of monies related to those manually matched invoices. The displaying of all outstanding invoices information 302 can correspond to invoice information from the total span of the timeline, total span of user information, secondary time period demarcations or other time periods along the timeline. This information 302 can display the total amount of outstanding invoices and total amount of monies related to those outstanding invoices.

The timeline data visualization can also include methods for filtering displayed invoice information. The vertical line 212 and vertical line 210 can correspond to the filtered date range 308. This filtered date range 308 can display the time period shown by the vertical lines 210 and 212 or that time period can be manually inputted in the filtering tab 310. The filtered date range 308 can filter what invoices are displayed on the display screen such as the displayed invoice information 309. This displayed invoice information 309 can also be filter by the type of invoice 307 through multiple methods such as through a user inputting the filter in the filtering tab 310 or through a user interacting with the all invoices display 301, the auto matched display 302, the manually matched display 303, or the outstanding display 304 through a method such as clicking with a mouse. Further options for filtering such as customer name, customer number, invoice number, currency, monetary amount, current balance due, location, purpose, and any other financial information can be utilized by a user through options in the filtering tab 310. The displayed invoice information 309 displays every invoice that corresponds to the filters applied by the user. Each invoice displayed 309 is displayed in an order based on user inputs or system preferences such as alphabetical order, numerical order, by date, or by other user inputted filter options.

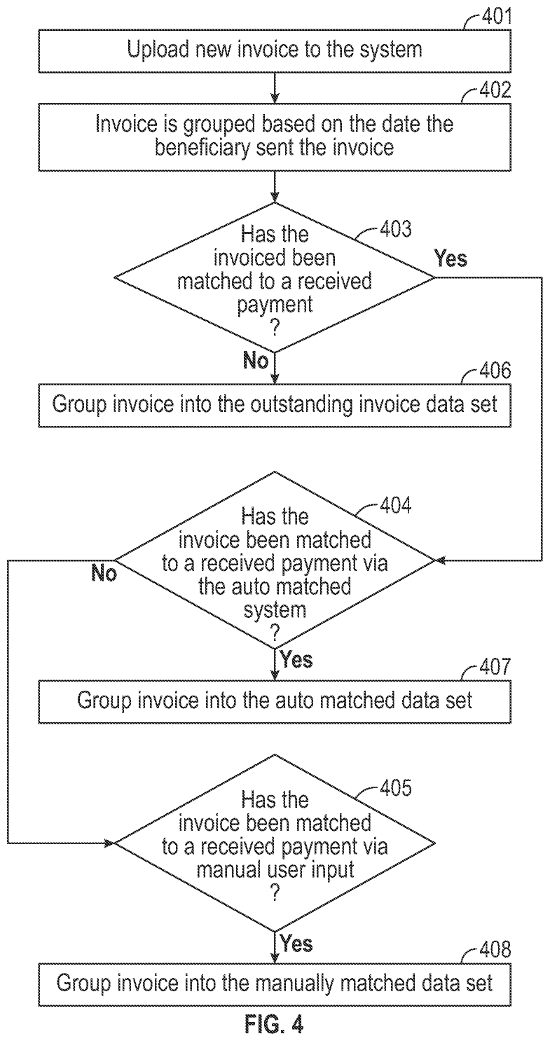

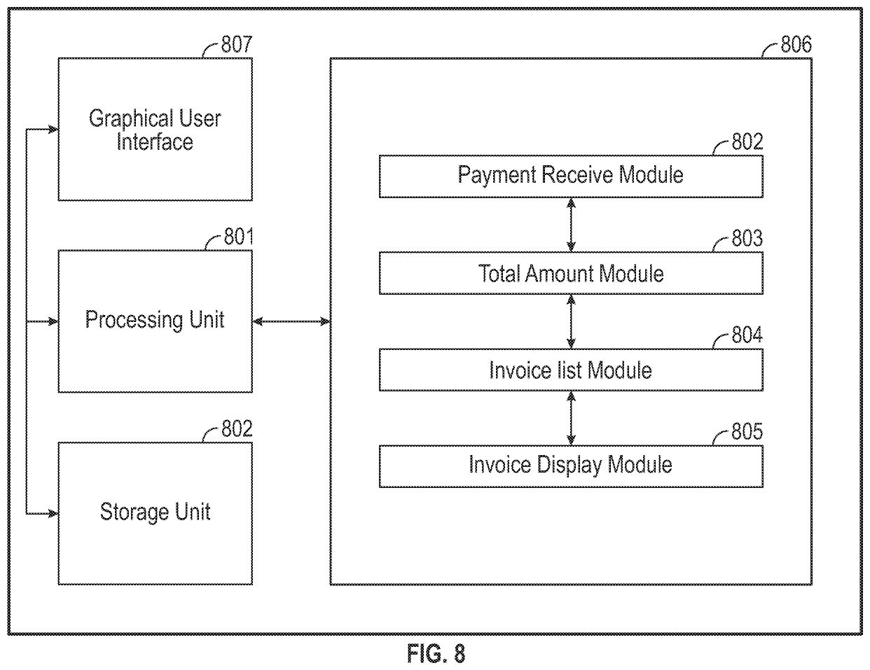

FIG. 4 describes one embodiment and process regarding a timeline data visualization on a display screen. FIG. 4 is further described and illustrated in FIG. 8, wherein the process can be the invoice list module 804. First, a new invoice is uploaded into the system through a personal computing device 101, the server 103, or any other possible method. That invoice is then stored on the storage device 104, the server 103, the network 102, or on any other possible storage device 401. The invoice is then processed by the system and grouped based on the date the beneficiary or user sent the invoice to the customer, remitter, or payor 402.

The software then searches and processes the invoice to determine if a received payment has been matched to the invoice 403. If the invoice has not been matched to a payment through any method, or there is no payment received for the invoice, the invoice is grouped into the outstanding invoice data set 406. These groupings and classifications are financial data regarding the invoice. If there has been a payment received for the invoice, and that payment has been matched to the invoice through any method, the software searches to determine whether the payment was auto matched to the invoice 404. Auto matching a payment to the invoice can be done through system settings, software processes, computer algorithms, or any method not including manual user inputs. If the invoice has been auto matched to the invoice, the invoice is grouped into the auto matched data set 407.

If the received payment has not been auto matched to the invoice, the software then searches to determine whether the received payment was manually matched to the invoice 405. If the received payment has been manually matched or is set to be manually matched to the invoice, the invoice is grouped into the manually matched data set. The manually matched data set can also be called team matched, user matched, or any other name that describes a process of a user manually inputting the information.

This process is repeated anytime a new invoice is uploaded into the system by any method. Additionally, the grouping steps 402, 403, 404, 405, 406, 407, 408 can be run by the software anytime new information is uploaded into the system.

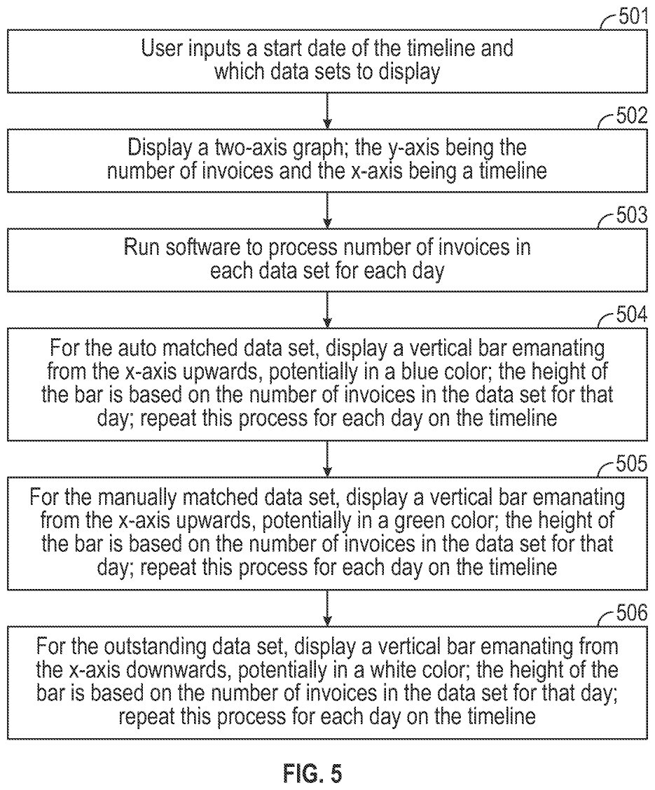

FIG. 5 describes one embodiment and process regarding a timeline data visualization on a display screen. FIG. 5 is further described and illustrated in FIG. 8, wherein the process can be the invoice display module 805. First, the user inputs a start date of the timeline 501. This input is completed through manual user input, through system settings, through program settings, or other automatic methods. The start date of the timeline can be determined through the methods described in the specification, for example, the user clicking on an user interactive filter 305, 306. Additionally, the user can manually select which invoices, data sets, and financial information to be displayed 501. This input is completed through manual user input, through system settings, through program settings, or other automatic methods.

The software then may work with the graphical user interface 105, 807 to display a two-axis graph wherein the y-axis 206 represents the number of invoices and the x-axis represents the timeline 201 on the display screen 502. This timeline data visualization can be of different sizes, shapes, orientations, or positions depending on the need in the embodiment.

The software then may process the number of invoices in each data set for each day 503. The software may run the processes 504, 505, 506 in any order and the processes can be run anytime new information is added to the system, new information is changed in the system, upon user command, or for any other reason needed by the user or the embodiment.

For the auto matched data set, the display is described in the description of FIG. 2. This process of updating information, running the software, or displaying the financial data is repeated for each vertical bar 204 or day of the timeline 504. For the manually matched data set, the display is described in the description of FIG. 2. This process of updating information, running the software, or displaying the financial data is repeated for each vertical bar 204 or day of the timeline 505. For the outstanding data set, the display is described in the description of FIG. 2. This process of updating information, running the software, or displaying the financial data is repeated for each vertical bar 204 or day of the timeline 506.

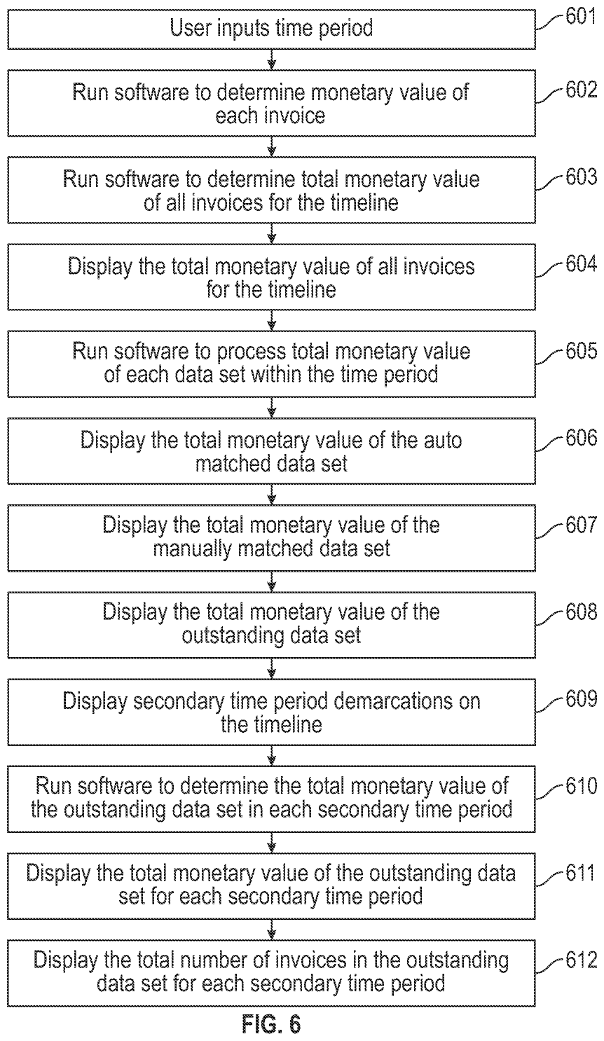

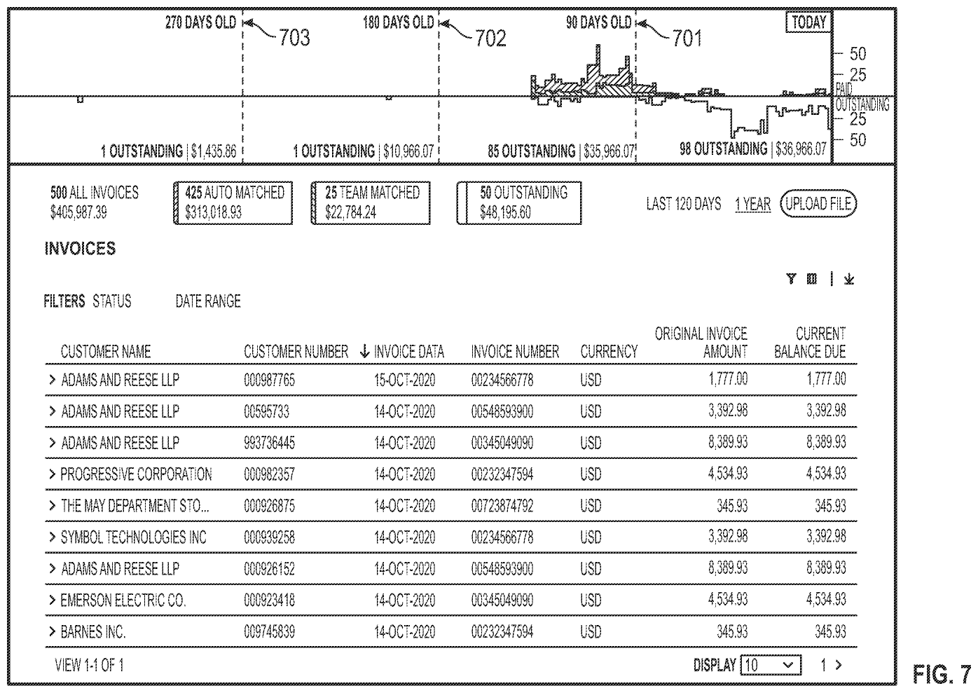

FIG. 6 describes one embodiment and process regarding a timeline data visualization on a display screen. FIG. 6 is further described and illustrated in FIG. 8, wherein the process can be the total amount module 803. First, the user inputs a time period of the timeline 601. This inputting of a time period is described in FIG. 2, FIG. 3, and FIG. 7.

The software may run the processes 602, 603, 604, 605, 606, 607, 608, 609, 610, 611, 612 in any order and the processes can be run anytime new information is added to the system, new information is changed in the system, upon user command, or for any other reason needed by the user or the embodiment.

The description of the processes 602, 603, 604, 605, 606, 607, 608, 609, 610, 611, 612 the software may run are partially outlined in the descriptions of FIG. 2, FIG. 3, and FIG. 7. The displays described herein can be oriented or positioned in any number of ways and can be displayed with any type of text, color, or formatting.

FIG. 7 shows one possible embodiment of a timeline data visualization on a display screen. In this embodiment, the user has selected or the system has been set to display a one year time span for the timeline. The user can select this display by clicking the user interactive filter 306. When the timeline is set to the one year time span the elapsed amounts of time between the vertical line demarcations 211 changes. These changes are displayed as text 701, 702, 703.

Additional embodiments of a timeline data visualization could include different timeline ranges than what is displayed in FIG. 7 such as for two years, 5 years, or any amount of time. The vertical lines 211 and time period demarcations displayed as text 701-703 can also change to correspond with different timeline ranges.

FIG. 8 is a block diagram to illustrate the timeline data visualization. The system described in FIG. 1 includes a storage unit 104, 802, a graphical user interface 101, 807, and a processing unit 101, 801. The storage unit 104, 802 stores a plurality of computer program instructions 806. The graphical user interface 105, 807 displays a graphical output of the plurality of processed computer program instructions.

The processing unit 101, 801 is coupled to the storage unit 104, 802 and the graphical user interface 105, 807 for processing the plurality of computer program instructions 806. The plurality of computer program instructions 806 includes a payment receive module 802, a total amount module 803, an invoice list module 804, and an invoice display module 805.

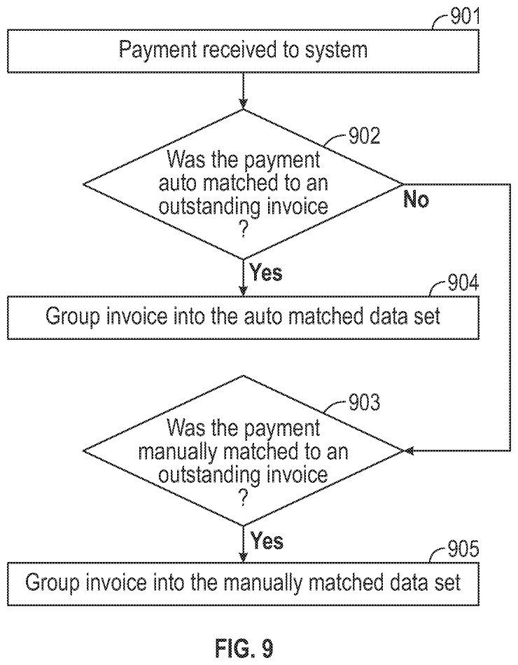

The payment receive module 802 receives a payment associated with a user and a customer(s) invoice(s). The payment receive module 802 is further described in FIG. 9. The total amount module 803 is coupled to the payment receive module to display the total amount of monies associated with invoices and different financial data. The total amount module 803 is further described in FIG. 6. The invoice list module 804 is coupled to the payment receive module 802 and the invoice display module 805 to display a list of invoices generated by the user, this list is further filtered by the process and embodiments described in this specification. The invoice list module 804 is further described in FIG. 4. The invoice display module 805 is coupled with the payment receive module 802, the total amount module 803, and the invoice list module 804 to display a timeline data visualization. The invoice display module 802 is further described in FIG. 5.

Examples of the storage unit 802 includes but not limited to a permanent mass storage device, such as random access memory (RAM), read only memory (ROM), a disk drive, a solid state drive, flash memory, etc., as a non-transitory computer-readable storage medium.

The graphical user interface (GUI) 807 discussed herein may be provided in the form of text-based user interface systems, virtual, augmented, or mixed reality (VAMR) interface systems, projection based systems, gesture controlled systems, and/or any other type of visual user interfaces. Although some of the principles discussed herein are discussed specifically with respect to, for example, a GUI, however, no limitation is intended, and the principles discussed herein may equally be applied to other interface systems.

The processing unit 801 may have various implementations without deviating from the scope of the present inventions. For example, each of the processing unit may include any suitable device, such as a programmable circuit, integrated circuit, memory and I/O circuits, an application-specific integrated circuit, microcontroller, complex programmable logic device, other programmable circuits, or the like. Each of the processing unit 801 may also include a non-transitory computer-readable medium, such as random access memory (RAM), a read-only memory (ROM), an erasable programmable read-only memory (EPROM or Flash memory), or any other suitable medium. Instructions for performing the methods described above may be stored in the non-transitory computer-readable medium and executed by the respective processing unit identified in the description of the method.

FIG. 9 describes one embodiment and process regarding a timeline data visualization on a display screen. FIG. 9 is further described and illustrated in FIG. 8, wherein the process can be the payment received module 802.

First, a new payment is received into the system through a personal computing device 101, the server 103, or any other possible method 901. That payment information is then stored on the storage device 104, the server 103, the network 102, or on any other possible storage device. This input of a received payment can be completed through manual user input, through system settings, through program settings, or other automatic methods. The payment is then processed by the system and matched to it's invoice.

The software then searches and processes the received payment to determine how the received payment was matched to the invoice. The software determines whether the received payment was auto matched to an outstanding invoice 902. If the payment was auto matched to an outstanding invoice, that invoice is then removed from the outstanding invoice data set and grouped in the auto matched data set 904. Auto matching a payment to the invoice can be done through system settings, software processes, computer algorithms, or any method not including manual user inputs. These groupings and classifications are financial data regarding the invoice. The software determines whether the received payment was manually matched to an outstanding invoice 903. If the payment was manually matched to an outstanding invoice, that invoice is then removed from the outstanding invoice data set and grouped in the manually matched data set 905. The manually matched data set can also be called team matched, user matched, or any other name that describes a process of a user manually inputting the information.

This process is repeated anytime a new invoice is uploaded into the system by any method. Additionally, the grouping steps 902, 903, 904, 905 can be run by the software anytime new information is uploaded into the system, upon user command, or based on system or program settings.

All ranges and ratio limits disclosed in the specification and claims may be combined in any manner. Unless specifically stated otherwise, references to “a,” “an,” and/or “the” may include one or more than one, and that reference to an item in the singular may also include the item in the plural.

Although the inventions have been shown and described with respect to a certain embodiment or embodiments, equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the inventions. In addition, while a particular feature of the inventions may have been described above with respect to only one or more of several illustrated embodiments, such feature may be combined with one or more other features of the other embodiments, as may be desired and advantageous for any given or particular application.

The foregoing devices and operations, including their implementation, will be familiar to, and understood by, those having ordinary skill in the art. This user interface serves to overcome the problem of recognizing the status of invoices during invoice management.

The above description of the embodiments, alternative embodiments, and specific examples, are given by way of illustration and should not be viewed as limiting. Further, many changes and modifications within the scope of the present embodiments may be made without departing from the spirit thereof, and the present invention includes such changes and modifications.

1. a method comprising:
storing an invoice in a database;
grouping invoices based on a date a beneficiary sent an invoice;
grouping those invoices based on financial data into data sets, those data sets comprising:
an auto matched data set;
a manually matched data set; and
an outstanding data set; and
displaying vertical bars or portions thereof in an order based on a timeline, wherein:
a user sets a start date of the timeline by inputting an elapsed amount of time;
an end date of the timeline is the present day;
the timeline is a horizontal line;
the vertical bars emanate from the horizontal line;
there are multiple layers of these vertical bars;
each layer of vertical bars is a different color, comprising:
a layer of vertical bars corresponding to the auto matched data set emanating upwards;
a layer of vertical bars corresponding to the manually matched data set stacked above the layer of the auto matched data set emanating upwards; and
a layer of vertical bars corresponding to the outstanding data set emanating downwards; and
a height of each vertical bar corresponds to a number of invoices from that date in that data set.

2. The method of claim 1, wherein the data includes financial data.

3. The method of claim 1, wherein a total monetary value of the outstanding data set is displayed.

4. The method of claim 3, wherein the timeline is demarcated by time periods and the total monetary value of the outstanding data set for each time period is displayed.

5. The method of claim 1, wherein the invoice data is displayed on a graphical user interface.

6. The method of claim 1, wherein the user inputs a time period on the timeline, wherein the invoices that correspond to these dates are displayed on a graphical user interface.

7. an apparatus comprising:
one or more processors;
a processor readable storage device coupled to the one or more processors, the processor-readable storage device including one or more instructions for:
grouping invoice data based on a date a beneficiary sent an invoice;
grouping invoice data based on financial data, wherein this determination is updated automatically based on user inputs;
displaying vertical bars or portions thereof in a timeline, and providing a visualization in response thereto, wherein:
the vertical bars emanate from a central horizontal axis line;
the vertical bars are able to protrude upwards or downwards from the central horizontal axis line;
there are multiple layers of vertical bars;
each layer of bars is shown as a different color based on the financial data; and
a height of each vertical bar corresponds to a number of invoices from that date in that data set; and
providing the user an option to input a time period for the timeline.

8. The apparatus of claim 7, wherein a total monetary value of an outstanding data set is displayed.

9. The apparatus of claim 8, wherein the timeline is demarcated by user specified time periods and the total monetary value of the outstanding data set for each time period is displayed.

10. The apparatus of claim 7, wherein the invoice data is displayed on a graphical user interface.

11. The apparatus of claim 7, wherein the user inputs a time period on the timeline, wherein the invoices that correspond to these dates are displayed on a graphical user interface.

12. A non-transitory computer readable storage medium having instructions executable by a digital processor, the non-transitory computer readable medium including one or more instructions for:
storing an invoice in a database;
grouping invoices based on a date a beneficiary sent an invoice;
grouping those invoices based on transactional factors into data sets, those data sets comprising:
an auto matched data set;
a manually matched data set; and
an outstanding data set; and
displaying vertical bars or portions thereof in an order based on a timeline, wherein:
a user sets a start date of the timeline by inputting an elapsed amount of time;
an end date of the timeline is a present day;
the timeline is a horizontal line;
the vertical bars emanate from the horizontal line;
there are multiple layers of these vertical bars;
each layer of vertical bars is a different color, comprising:
a layer of vertical bars corresponding to the auto matched data set emanating upwards;
a layer of vertical bars corresponding to the manually matched data set stacked above the layer of the auto matched data set emanating upwards; and
a layer of vertical bars corresponding to the outstanding data set emanating downwards; and
a height of each vertical bar corresponds to a number of invoices from that date in that data set.

13. The non-transitory machine-readable media according to claim 12, wherein the data includes financial data.

14. The non-transitory machine-readable media according to claim 12, wherein a total monetary value of the outstanding data set is displayed.

15. The non-transitory machine-readable media according to claim 14, wherein the timeline is demarcated by user specified time periods and the total monetary value of the outstanding data set for each time period is displayed.

16. The non-transitory machine-readable media according to claim 12, wherein the invoice data is displayed on a graphical user interface.

17. The non-transitory machine-readable media according to claim 12, wherein the user inputs a time period on the timeline, wherein the invoices that correspond to these dates are displayed on a graphical user interface.
